(19) United States
(12) Patent Application Publication
(10) Pub. No.: US 2025/0053993 A1
(43) Pub. Date: Feb. 13, 2025

(54) CONFIGURABLE PRODUCT RETURN DETERMINATION USING COMPUTATIONAL MODELING

(71) Applicant: International Business Machines Corporation, Armonk, NY (US)

(72) Inventors: Nosaiba DAR MOUSA, Wappinger's Falls, NY (US); Warren BOLDRIN, Montgomery, NY (US); William J GREEN, Cary, NC (US); Karl Owen CASSERLY, Valley Stream, NY (US)

(21) Appl. No.: 18/448,375

(22) Filed: Aug. 11, 2023

(51) Int. Cl. G06Q 30/016; G06Q 30/0202

(52) U.S. Cl. CPC G06Q 30/016; G06Q 30/0202

(57) ABSTRACT

Configurable product return determination includes maintaining product profiles indicating updated configurations of products and their components, building and training a set of models configured to identify products that are expected returns, predict retention times for such products, and determine, based on quality indicators of the products and on requirements for reusability of components, reusable components of the products, and, using the set of models and a product profile of a product in use, determining that the product in use is expected to be returned in the future and an expected timeframe of the return of the product in use, and determining one or more components, of a set of components of the product in use, that are reusable upon return of the product in the future.

### BACKGROUND

Providers of high-tech equipment and other products, such as mainframe computing equipment as one example, often accept returns of products and the components of those products because of business, environmental, compliance, and other reasons. Acceptance of returned products is often important for sustainability reasons as well. Meanwhile, returned products sometimes include components that perform without issue and fall within required specifications for potential reuse, and therefore are potentially reusable.

### SUMMARY

Many companies accept and deal with returned products. Often times high-tech products and their components are configurable, multi-generational items subject to upgrade, downgrade, and maintenance, and it is common to have sale, lease, upgrade, and exchange arrangements in place. Additionally, fast-paced technology development and evolving customer needs contribute to dynamic product lifecycles as clients seek to adopt new technology at a relatively fast pace. This, in turn, results in returns. Return determination can be constructed as a heuristic, as whether and when a product will be returned is not generally known, and neither is the state (configuration, quality, etc.) of the product and components thereof when that product is returned (if at all).

Forecasting whether a product and its components will be returned, when, and the state of what is returned can be a consuming task. This, together with the complexity of high-tech, configurable, multi-generational products, can complicate production operations that might benefit from knowledge of anticipated returned equipment and the potential for reuse thereof. Consequently, accurate indications of products and components that are expected via prediction (as opposed to initiated actual return data) to be returned, their anticipated dates of availability, and prospects for reuse would be helpful.

Shortcomings of the prior art are overcome and additional advantages are provided through the provision of a computer-implemented method. The method includes maintaining product profiles of a plurality of products. The plurality of products includes respective components. The maintained product profiles indicate updated configurations of the plurality of products, including updated configurations of the respective components of the plurality of products. The method also includes building and training a set of models based on at least some of the maintained product profiles. The set of models are configured to identify products that are expected to be returned in the future. The set of models are also configured to predict retention times for products that are expected to be returned in the future. The set of models are additionally configured to determine reusable components of products that are expected to be returned in the future. Such determination of reusable components may be based on quality indicators of products that are expected to be returned in the future and on requirements for reusability of components. For a product in use that includes a set of components and for which a maintained product profile indicates a current configuration of the product in use, the method additionally includes using the set of models and the product profile to determine that the product in use is expected to be returned in the future and an expected timeframe of the return of the product in use, and to determine one or more components, of the set of components of the product in use, that are reusable upon return of the product in the future.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual representation of a return determination architecture, in accordance with aspects described herein;

FIGS. 3A-3B depict an example process for product retention determination, in accordance with aspects described herein;

FIG. 4 depicts an example process for product retention time determination, in accordance with aspects described herein;

FIG. 5 depicts example data structures associated with product retention determination and timing, in accordance with aspects described herein;

FIG. 6 depicts an example process for return quality determination, in accordance with aspects described herein;

FIG. 7 depicts further details of an example return determination module to incorporate and/or use aspects described herein; and

FIG. 8 depicts an example process for return determination, in accordance with aspects described herein.

### DETAILED DESCRIPTION

Described herein are approaches for determining expected return, timing, quantity, reusability, and quality of configurable products and components thereof (also referred to herein as assets), and thereby reducing uncertainty in the foregoing. Many companies develop products that are highly configurable, for instance where a single product model might have different configurations in terms of component parts for different customers/clients of a company. Meanwhile, in both sale and lease situations it is common for the company to eventually receive back the products, for instance because the client moves to a next generation of the product and/or a newer technology, as examples. This creates a situation in which components are received, and many of these components might be functionally sound and potentially reusable in remanufacturing operations.

Aspects described herein identify specific products and components thereof that are expected to be returned, identify the expected timing of these returns, and determine quality indicators useful for purposes of reusability determination, all of which can be performed at the product and/or component level. This activity is data-driven rather than theoretical, and considers alterations (upgrades, downgrades, replacements, maintenance, etc.) that might have occurred to the product and/or individual components thereof over time and prior to being returned. The possibility of such alterations and maintenance can add significant complexity to accurate return forecasting and quality determination.

In specific embodiments, aspect process real-time data and build sequential forecasting models to reduce uncertainty of return likelihood, timing, quantity, configuration, and quality. Since product details could change via alterations over time for any of various reasons, data from forward supply chains (as an example) can be used to extract knowledge about current product configuration. Product configuration in this context can refer to a configuration of the product overall and/or configuration(s) of each of the individual components (hardware and/or software) of the product. A product profile discussed below can therefore indicate updated configuration of the product, including updated configuration(s) of the components of the product.

In general, any data indicative of alterations, past, or current configuration of the product and/or its components could be useful and aggregated to facilitate the identification and determination of a current product configuration for maintaining as part of the product profile. From a forward supply chain standpoint, a company is generally aware of the products and number thereof that are in use in the ‘field’, or at least that were provided by the company to one or more clients, as well as an initial configuration of those products at the time of provision. In examples, this is taken from production/manufacturing data. After provision of a product to a client, the product might undergo maintenance, reconfiguration, upgrades, downgrades, etc., referred to herein as alterations. Data about such alterations can be aggregated with the initial configuration data to identify the current configuration of the product, including its current components and the configurations of those components. The identification of a current configuration can be critical for high-tech, configurable, multi-generational products for the reasons discussed above. The current configuration, and optionally a history of the product/component configuration, can be included as part of a product/asset profile that is being maintained. A process can maintain a product profile of each of a plurality of products. Each such product can include a respective set of components. The product profile of a product can indicate an updated configuration of the product, including updated configuration(s) of the respective component(s) of that product. Such product profiles can be for products that are in use currently or that were in use and later returned in whole or in part.

Data about the client/customer that is the owner, lessee, etc. of the product can also be maintained in a client profile, which could optionally be part of a product/asset profile. In any case, data from the profiles can be merged, cleansed, and processed to feed model building and training, for instance the building and training of artificial intelligence (AI) models. Thus, in one aspect, a process builds and trains a set of models based on at least some of the product profiles being maintained. The set of models are configured to perform certain aspects. The set of model(s) can include one or more models. In the case of multiple models, each model could have one or more discrete functions that differ from the function(s) of other models of the set. Additionally, the training of such model(s) could be performed periodically and/or aperiodically. The product and client profiles are maintained over time because the data being maintained can change and therefore inform updated training of the model(s). New product launches and other developments in technology, for instance, might cause changes in return rates and/or alterations in various products, which in turn results in changes to the data relevant for proper training of the model(s).

One example model is a prediction model configured to identify whether/which product(s) will, with some level of confidence or expectation, be returned in the future. In some examples, the prediction is defined as binary classification problem in which a target product is classified as either a (likely) return or a (likely) non-return. For products classified as returns a process can quantify a number of products to be returned and their configurations, and this quantification could be as granular as desired. For example, the quantification could be made down to the component level, as the configurations and components of products expected to be returned are known.

Another example model is configured to make a retention prediction as to how long a client will keep a product expected for return. In other words, for a product that is expected to be returned as indicated by the prediction model discussed above, the retention model can predict a retention time of the product. In examples, this model is implemented as a regression model. With an expected retention time, a timeframe for the return can be determined. In examples where the retention time is a total amount of time from the provision of the product to the return of the product, the timeframe can be determined by adding the retention time to the time the product was provided to the client. The timeframe can be formulated as a window of time in the future. As an example, if the retention time for a given product is predicted to be 17 months before it is returned and the product was provided to a client on Jan. 1, 2023, then the timeframe for the return could be Jun. 1, 2024 (or some window of time around that date), as an example.

In another aspect, a model is built and trained to determine reusable components of products that are expected to be returned in the future. Such determination could be based on quality indicators of products that are expected to be returned in the future and on requirements for reusability of components. Quality indicators of predicted returns can be pulled from quality systems, for instance. Issues, flags, or other types of indicators can be extracted and aggregated for each predicted return, and this data can be merged/compared with engineering requirements, for instance safety and privacy standards, to identify whether/which return components/parts are reusable.

With the model(s) built and trained, they can then be used in conjunction with input data associated with a product in use, including a current configuration of the product in use and current configuration of the set of components of the product in use, to determine whether the product in use is expected to be returned in the future, and, if so, an expected timeframe of the return of the product in use as well as whether or not individual component(s), of the set of components of the product in use, are reusable upon return of the product in the future. Thus, from the data about products in use, the model(s) can identify/predict which will be returned, when, and which components are reusable on return. This can be repeated for a collection of other products, and the results can be aggregated across those products if desired to quantify expected reusable return components at any level of granularity, for instance for each specific component, for a specific machine type and model having multiple components, etc.

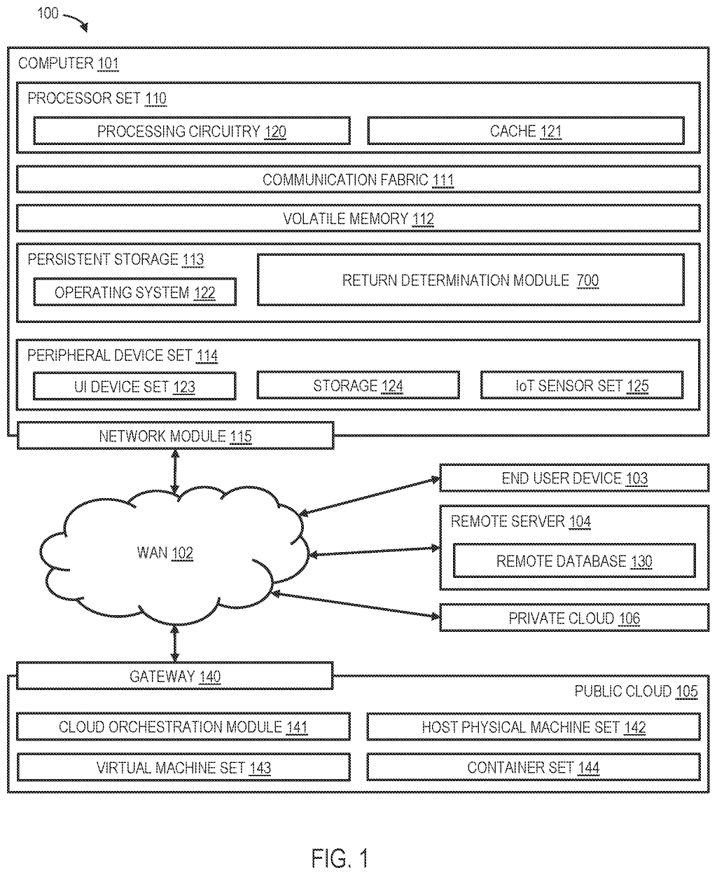

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing aspects of the present disclosure, such as code of return determination module 700. In addition to block 700, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 700, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 700 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 700 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

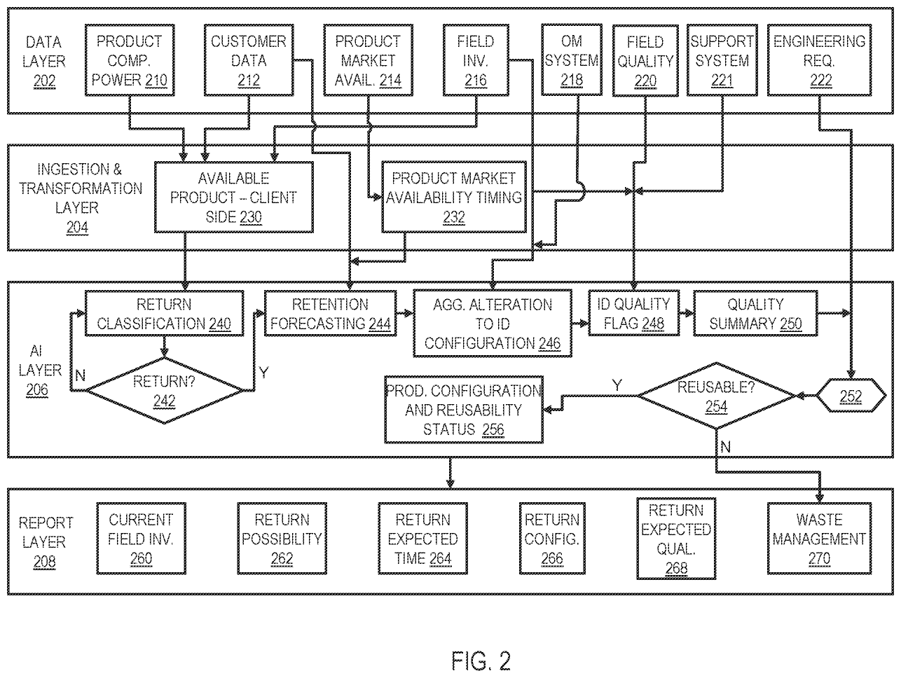

FIG. 2 depicts an example conceptual representation of a return determination architecture, in accordance with aspects described herein. The architecture includes a data layer 202, ingestion and transformation layer 204, AI layer 206, and report layer 208.

Data layer 202 includes various sources and types of data that may be used in aspects described herein. Product computation power 210 indicates the computational capabilities of products as informed by the particular components of the product. Customer data 212 houses data about the relationships between the company/provider of products and clients of that provider, for instance details about the clients such as the client's industry/sector, size, region (e.g., country, locale), as examples. Product market availability 214 houses data about products and/or technology that is, or was, available on the market, for example indications of current technology, previous technology, and new technology that has been or is about to be released, as this can influence client decisions regarding returns. Field inventory 216 is an inventory of products (and therefore components thereof) in use, and could be based, for example, on product/component order data from the order management system 218. In examples, the order management system 218 is a system maintained by a production/manufacturing division that receives and fulfills orders, and therefore maintains manufacturing details like part numbers and other details about the product and its components. The order data can be used in maintaining a product profile of a product in use, in which a process obtains order data associated with the product in use, which order data including details of product components at a time of provision of the product in use to a client (initial configuration), and maintains a current configuration of the product in use by tracking and analyzing changes in configuration of the product over time, including alterations to the set of components of the product. Some information about alterations could come from subsequent orders via the order management system, for instance if replacement or upgraded parts for the product are ordered, fulfilled, and installed. Field quality data 220 and data from support system 221 relates to, and informs of, the quality of a product/components. Often times a client will rely on the manufacturer/provider of a product to service, maintain, and support the product. This provides quality data that can be reported and maintained, and that is informative of the quality of components expected to be returned and therefore their potential for reuse. Lastly with respect to the data layer, engineering requirements 222 can inform of requirements (e.g., specifications, thresholds, tolerances, etc.) for reusability of components, for instance safety and/or privacy related requirements. It may be best practice to never reuse a particular component because of safety, security, or privacy risks associated with doing so, for instance.

Ingestion and transformation layer 204 includes an available product component 230 for determining, based on product computation power 210, customer data 212, and field inventory 216, a client's product(s) and properties thereof. Product market availability timing component 232 determines/predicts timing as to the availability (both availability and lack thereof) of products in the marketplace.

At the AI layer 206, return classifications 240 as to products on the client side (230) are made in accordance with aspects described herein using, for example, one or more AI models. This may be made as part of an ongoing process relative to all/multiple products in use by one or more clients. For each given product in use, an inquiry 242 is made as to whether it is expected to be returned. If so, (242, Y), retention forecasting 244 is performed based on, e.g., customer data 212 and product market availability timing 232, and predicts a retention time for the product in use. Additionally at the AI layer 206, field inventory 216 and data from the order management system 218 are used by component 246 to aggregate the alterations made to the product and identify the product's latest (current) configuration. Field inventory data 216, field quality data 220, and support system 221 data feed quality determination component 248 to identify quality indicators of the product, including components thereof. This is used to produce a quality summary 250 which is aggregated 252 with engineering requirements 222 and fed into a determination 254 as to whether the product and/or components thereof are reusable. If so (254, Y), a product configuration and reusability status 256 is built with this information.

At the report layer 208, various reports are generated. A current field inventory report 260 indicates inventory of products in the field. A return possibility report 262 reports on which products are expected to be returned and optionally the confidences/likelihoods of those returns. A return expected time report 264 indicates the retention times and/or expected timeframes for return of products that are expected to be returned in the future. A return configuration report 266 indicates the configurations of products expected to be returned. A return expected quality report 268 indicates the expected quality of products/components thereof that are expected to be returned. Additionally, waste management report 270 indicates (for instance based on determinations as to products/components that are not reusable (254, N)) waste associated with the expected returns. The waste is expected to require appropriate handling.

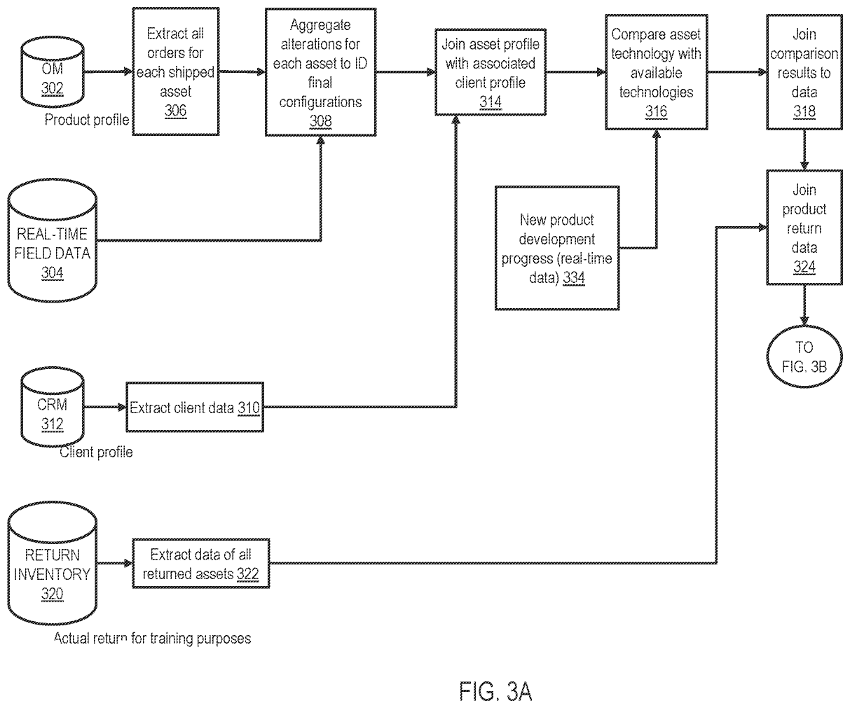

FIGS. 3A-3B depict an example process for product retention determination, in accordance with aspects described herein. In an aspect, a set of models are built and trained based on (at least) maintained product profiles. The set of models can include a prediction model configured to make a prediction, in a first phase, that a product in use is expected to be returned in the future. Referring to FIG. 3A and the building/training of this model, maintenance of a product profile based on order data for shipped assets (products, components) includes extracting (306) order data from order management database 302, and aggregating (308) alterations as informed from real-time field data 304 for each product to identify a latest configuration of the product, including components thereof, for maintaining this configuration in the product profile. In addition, client profile data from a client profile database 312 is extracted (310) and joined (314) into the asset profile. Example client data includes, but is not limited to, a client size, client industry, and/or client location. Also joined (318) are the results of comparing (316) the asset technology with available technology. Additionally, return data is maintained in a return inventory database 320. The return data indicates which products were returned and when they were returned. As part of training the prediction model, this data is extracted (322) and joined (324) with the data produced through 318 as part of the product profile. Referring to FIG. 3B, a return status for each asset is also maintained as part of the product profile, where if the product was returned (325, Y), it has a return status set to 1 (326) and if the asset was not yet returned (325, N), it has a return status set to 0 (328). The return status is joined into the profile (330) and any desired data aggregation and transformation is performed (332).

The following presents example pseudocode for data integration and aggregation logic in accordance with aspects described herein. Order management system data is aggregated to identify final components/configuration of an asset. Client information and available technology is considered, as is return data in the form of retention decisions and time of retention.

```
-Extract order data
-Extract client data including size, industry, etc.
-Extract Product/technology availability date from product portfolio
-Extract asset_id and return date from return inventory
-For each shipped asset id:
  -Sort records by order date in increasing order
  -Set first order as a reference point
  -For each order associated with asset_id:
    -add/abstract configuration changes
  -Join asset details with associated client profile
  -Compare asset to product portfolio:
    -From products portfolio:
      -is there a newer technology?
      -is there a newer product?
    -join comparisons results
  -Merge data with return data on asset_id and client_id
  -If asset_id is available in return inventory:
    -set the retention_decision to 1
    -set retention_period to the difference between installation data
    (from order details) and return date
  -else:
    -set retention_decision to 0
```

The prediction model to predict whether a product in use is expected to be returned in the future may be trained from the aggregated data, since return status is known for a collection of products. After the model has been trained, data obtained in real time relating to a product currently in use can be used to predict whether the product in use is expected to be returned in the future. Referring still to FIG. 3A, for a given product in use, the product profile being maintained and having a current configuration of the product in use is obtained. Meanwhile, the client profile of the client to which the product in use was provided can be obtained from customer relationship management (CRM) database 312. As part of the comparison at 316, information about new product development progress 334 (for instance, the latest data about development by the company/provider of the product in use or by another company) may be fed into the comparison 316. In this regard, the prediction model can consider features such as whether the product in use is current technology, whether previous technology remains available to purchase, and/or whether newer technology is available to replace the product in use, as examples. By way of example, if the given product in use is Generation 2 of the product, then whether that Generation 2 is the latest technology, whether Generation 1 is still available/new on the market, and whether there is a Generation 3 are all examples of potentially significant features of a prediction decision as to whether the product is expected to be returned in the future.

The data for the product in use and about which a retention decision is being made is joined/aggregated as described. The model is configured to predict a retention decision as a classification problem at 336 (FIG. 3B). This can be performed for a collection of products in use, and potentially across different clients. For any product classified by the prediction model as being a return (i.e., expected to be returned in the future), the process identifies (338) that product and a quantity of each component of that specific product, determines a total return number of products and/or various properties of those, for instance model machine types and models (340), and determines a total return quantity for each component (342). Various aggregation(s) can be performed as well, for instance to aggregate quantities on a product and/or component level, if desired.

The set of models can also include a retention model that is configured to predict, in a second phase, an amount of time a product in use will be retained before it is returned. This can be used to determine an expected timeframe of a return of the product in use. In examples, the retention model predicts, for a given product in use, a total amount of time the product will be retained after it is provided to the client, and this total amount of time can be added to an initial date, for instance the date the product was actually provided to the client, to estimate a timeframe during which the product is expected to be returned.

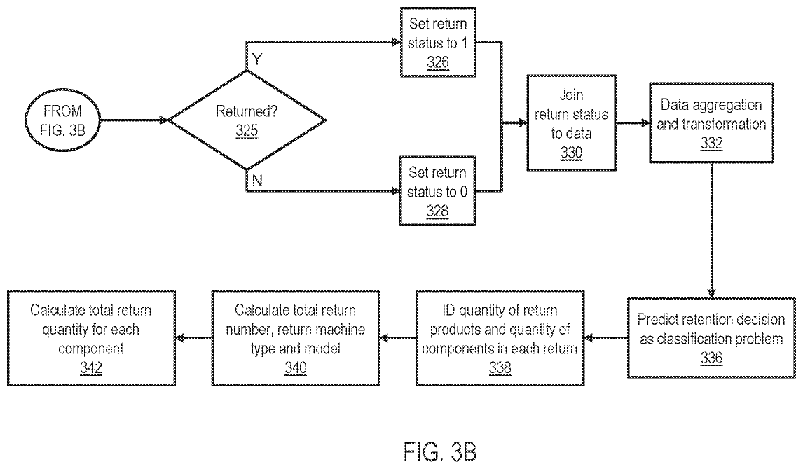

FIG. 4 depicts an example process for product retention time determination, in accordance with aspects described herein. The process extracts (410) client data from the client profile maintained in the CRM database 412, extracts (406) order data for each shipped asset from the product profile maintained in the order management database 402, and extracts (422) data of all returned assets from return inventory database 420. This information can be used to build and train the retention model to predict an amount of time a product in use will be retained from an initial date before it is returned. For instance, the extracted client data from 410 and order data from 406 can be aggregated (450) together and further aggregated (452) with determined retention times 454 determined by aggregating (456) the extracted order data from 406 and return data from 422. The process filters (458) this data to select products that were returned, and uses this to train (460) a retention regression model. The model can then be used to make predictions for each of a collection of products in use and are expected to be returned in the future. For any product classified by the prediction model described above as being expected for return, the process of FIG. 4 predicts (462) a retention time. This is done (464) for each product classified as a return. Then using a provision date (for instance order or fulfillment date) and predicted retention time for each product, the process determines (466) when (e.g., as a timeframe) the product is expected to be returned.

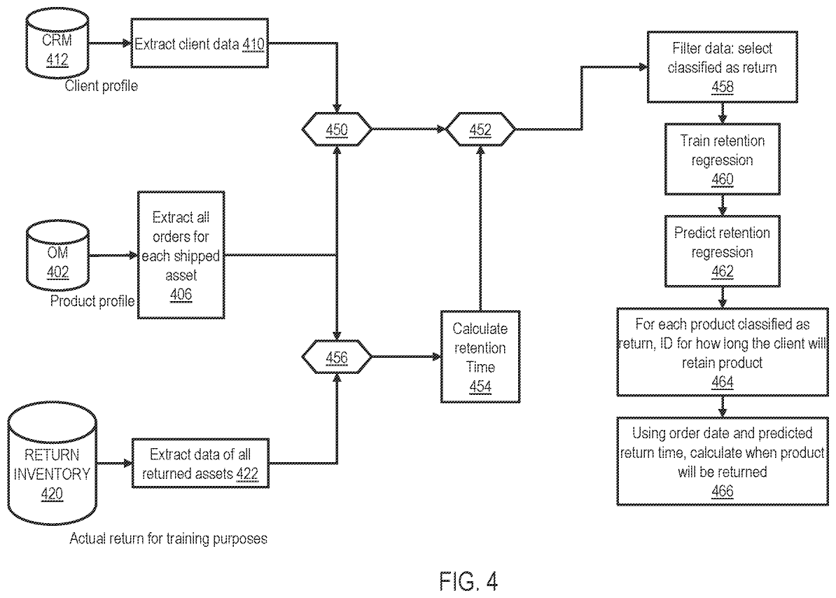

FIG. 5 depicts example data structures associated with product retention determination and timing, in accordance with aspects described herein. The structures can be used to house and aggregate data in accordance with aspects described above with reference to FIGS. 3A, 3B and 4. An example data structure of CRM database 512 is table 514 of client profiles. Table 514 has columns for client identifier, client industry, client region, and client sector, among other data points. An example data structure of order management database 502 is table 504. Table 504 has columns for order identifier, date of order, client identifier, serial identifier, machine model, machine type, and running configuration properties for the asset. It is noted that the serial identifier could be the key to track alterations made over time, via various orders, to a product and therefore inform a final/latest/current configuration of the product.

An example data structure of return inventory database 520 is table 522 with columns for client identifier, serial identifier, and receiving date (data on which the return was received from the client), where, again, serial identifier may be used as the key to identify the specific product being returned.

In this example, information from the three tables 514, 504, 522 is aggregated 523 to produce table 524. Specifically, table 524 includes columns to indicate return status, retention time, serial identifier, machine model, machine type, and final (current) configurations, including for the components of the products. Table 524 also includes columns to indicate available technology relative to the products, and based on product portfolio 528 and ascertaining available technology 526 based thereon. In this example, table 524 includes indications of whether the products are current technology, whether there is newer technology available, and whether the previous technology remains available.

With respect to the retention decisions for given products in use, i.e., whether the products are expected to be returned, data of the client profiles and product profiles for the products can be aggregated and reflected in table 524 to inform current configurations of the products, among other information. A built and trained retention classification model is used to identify the quantity of the return products and quantity of components in each of the returns. This information can be aggregated to calculate a total return number, return machine type and model, total return quantity for each of the various components, etc.

With respect to retention timing, the retention time is maintained as part of table 524 (calculated 525 from the date, client_ID, serial_ID, and receiving date information of tables 504 and 522), and the retention model can be built and trained on the information therein. The product availability information in table 524, such as information about timing of the release of new products/technology, for instance, can also be a relevant feature for predicting retention time. In any case, for each product classified as being an expected return, the process can identify how long the client is expected to keep the product and, using the provision date (e.g., order date) and that predicted retention time, determine a timeframe for the product return in the future.

One or more AI models could be built and trained for determining, in a third phase, reusable components of products that are expected to be returned in the future. Such determinations could be based on quality indicators of the products that are expected to be returned in the future and requirements for reusability of components, for instance.

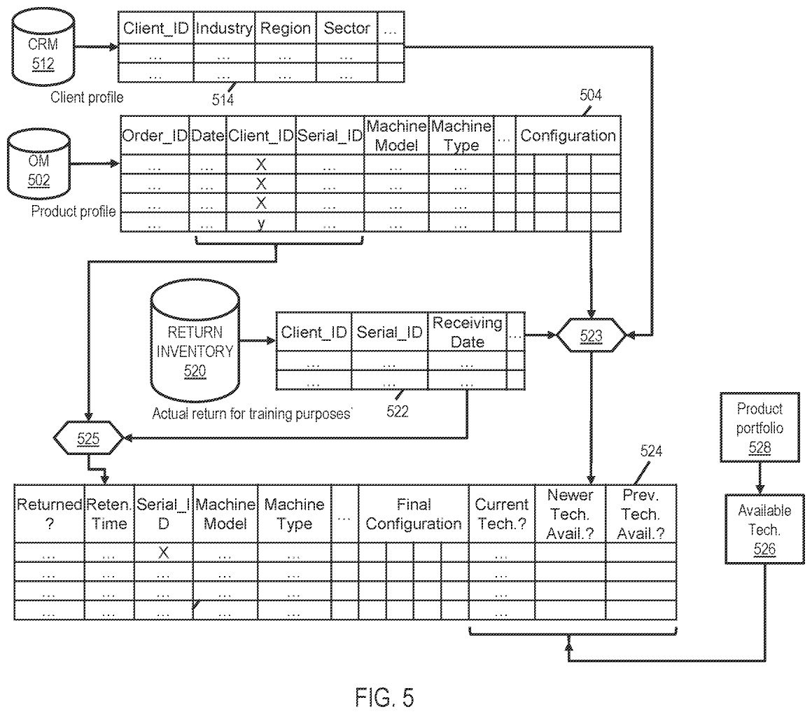

FIG. 6 depicts an example process and related data structures for return quality determination, in accordance with aspects described herein. Return quality can related to reusability of a product and/or individual components of the product. The process aggregates (602) support/maintenance data from support system 604 with data 606 of predicted returns from the first and second phases. Data 606, presented as a table in this example, includes (at least) return status, retention time, serial identifier, machine model, machine type, and current configuration data for the products. The process extracts (608) maintenance/defect records for each product predicted as a return, including for the individual components of the product. Additionally, the process aggregates (610) the data 606 and field quality data from field quality database 612 to extract (614) quality indicators for each product predicted as a return, including quality indicators for the individual components of the product. The extracted maintenance/defect records and quality indicators are aggregated (616) with a list (618) of (potentially) reusable components determined based on engineering requirements (620) as to the reusability/remanufacturing of components and fed into a filter layer 622 to identify the reusability of each component in each of the products marked as an expected return. Table 624 depicts example results of the filtering 622, namely a table that includes at least serial identifier, machine model, machine type, and reusable component(s) for each of a collection of products. A report 626 is output as to the reusable component(s) of each product. The process reports 628 a total number of reusable components across one or more products. The process also, based on the reusable components (630), a product marketing plan 632 for existing/new products, and product engineering requirements 634, identifies (636) a product for remanufacturing (e.g., replacing one or more components) and identifies (638) a product as being saleable as-is.

In this manner, out of the product(s) expected to be returned, data useful for determining expected qualities of the product(s) and their components are gathered from different sources, for instance a support system and field quality database. The maintenance of the product profile of a product in use can therefore include obtaining quality indicators, e.g., from field quality data associated with the product in use, and maintenance data indicating maintenance performed on the product in use. A determination as to one or more components that are reusable upon return of the product in use can include comparison(s) of the quality indicators and the maintenance data to various requirements for reusability of the components, in order to determine which components of the product in use satisfy the requirements of reusability thereof. This informs which components from each of various products can be reused when returned.

The reporting of the reusable component(s) can be done with any desired level of granularity. In examples, each reusable component of each of the products predicted to be returned is identified, and a list is produced for each such product, the list being a list of the reusable component(s) of that product. This reusability determination can be repeated for a collection of other products in use. Since various different products to be returned might have the same/similar components, the process can aggregate results by component to determine a collection of reusable components (optionally broken into component type, model, quality, etc.), timing when each reusable component of the collection will be available in the future, configuration of each reusable component of the collection, and quality of each reusable component of the collection. Based on making these determinations relative to products to be returned, the process can identify product(s) to remanufacture and/or potentially resell as-is (e.g., if the product has all reusable components). This also can be used to plan for remanufacturing operations and inventory, facilitating better inventory management and potentially reducing procurement levels for new components.

Aspects can be performed periodically and/or aperiodically, and in real-time as new data arrives. Existing AI model(s) can be periodically and/or aperiodically retrained, or new models can be built and trained to perform aspects described herein. For any product in use, predictions as to whether the product is expected to be returned can be made over time. It might be predicted at a given time that a given product is expected to be returned in the future and within a predicted timeframe in the future. Alternatively, the product might not be predicted, at the given time, to be returned in the future, but might, at some later time, be predicted to be returned in the future. Furthermore, considerations as to product availability and new technology can contribute to return and retention predictions.

Accordingly, aspects can transform client and order data to forecast product returns. The framework described herein to forecast product returns can be applied to high-tech products, including computer hardware products. The predictions can help reduce uncertainty in return quantity, timing, and quality. An example forecasting method proceeds with respect to a product return in three sequential stages:
(i) Forecast the return quantity as a retention decision and solve as a classification problem: For training purpose, historical order and return inventory data can be used to train a machine learning-based AI model. A process aggregates order data to provide final content (configuration) of each asset (product) available in the field. Processed order data is joined with historical return inventory. An asset that has been returned has an associated returned value set to indicate a return (e.g., 1), otherwise set to indicate that it was not returned (e.g., 0). A classification model can be built using a classification algorithm such as a logistic regression or decision tree classifier. The model is then used to predict whether, and which, other assets are expected to be returned. If an asset is predicted (at least at the current time) not to be returned, the prediction can be run one or more times thereafter to track a potential return of this product. If the asset is predicted to be returned, the data of the asset predicted to be a return can be fed to a next stage and the quantity of each component of the asset can be reported.
(ii) Forecast return timing as a retention period and solve as a regression problem: The prepared historical data from the retention decision model can be augmented with another feature-retention period of each product. A difference can be calculated between an original order provision/shipping/installation date and an actual return date. A regression model for retention timing can be built using any regression algorithm, such as linear regression of a gaussian process regression. For new records (i.e., a product predicted to be returned in the future), the retention timing model can be used to predict when a given product predicted to be returned is expected to be returned. The model could output, for example, a number of days/weeks that the client is expected to keep the asset before returning it. This number can be added to the provision/shipping/installation date of the product to determine a timeframe when the asset will be returned.
(iii) Use multiple data sources including field quality and maintenance data to determine quality of products and components forecasted for return, and thereby reduce return quality uncertainty. Example pseudocode of logic for identifying expected return quality is as follows:

```
Initialize reusable_components //a variable to indicate components
    identified as reusable
Initialize unresuable_components //a variable to indicate components
    identified as non-reusable
Initialize data from previous stage //gather data from the retention
    decision/timing stages
From the support system −> Extract support data for all assets forecasted
    as a return //collect from the support system the data related to
    products expected to be returned
From field_quality −> Extract field_quality data for all asset forecasted
    as return //collect field quality data about the products expected
    to be returned
From engineering documents −> Extract list of reusable components/parts
    //the engineering requirements for reusability of components include
    safety or privacy related requirements, for instance, that are required
    for reusability of components of the product in use
Join data of asset predicted as return with support data //join product data
    with the support data about that specific product
Join data with field_quality //join product data with the field quality data
    about that specific product
For each asset_id forecasted as a return:
  For each component/part indicated by engineering requirements as
  potentially reusable:
      aggregate quality flags
      if quality flags meet reuse criteria:
        update reusable reusable_components //add component to
        list of reusable components
      else:
        update unresuable_components //add component to list of
        non-reusable components
```

Aspects described herein have advantages in that they can inform of incoming reusable inventory for repurposing, potentially generate additional revenue based on a reverse supply chain, and also streamline remanufacturing sales and production operations. Aspects can reduce remanufacturing/ordering cost, maximize utilization of return inventory, reduce inventory level and cost, and quantify the number of configurations that might potentially be sold as-is. Aspects also help ensure component/part availability, recommend product configuration(s) that can be built using incoming reusable components, and recommend a new or refurbished product for a client who might potentially return a product.

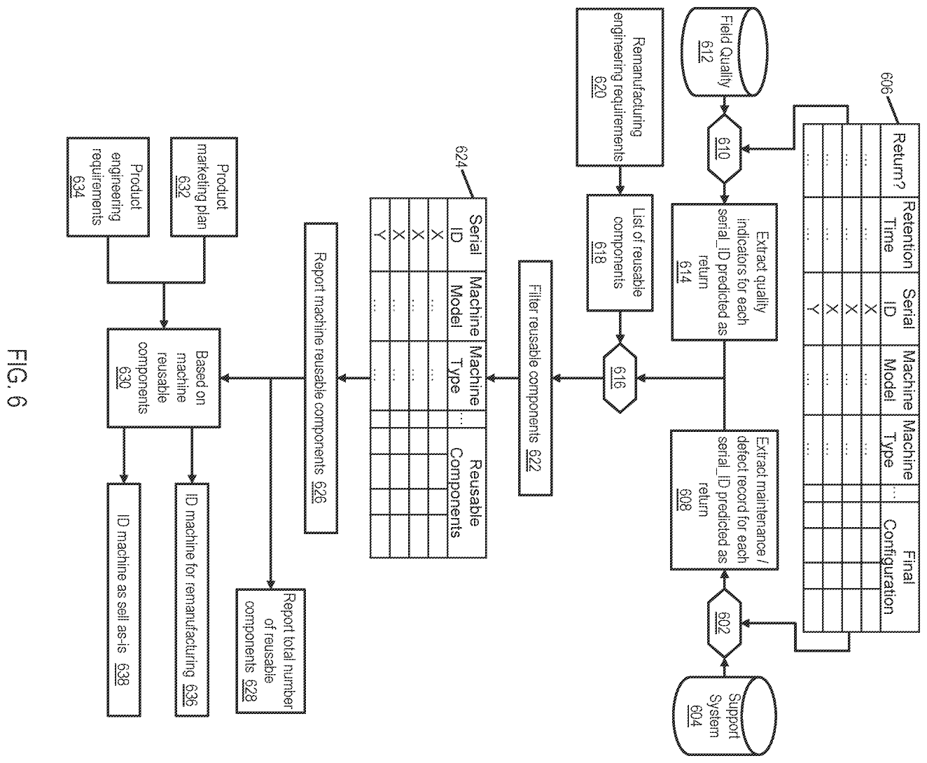

FIG. 7 depicts further details of an example return determination module (e.g., return determination module 700 of FIG. 1) to incorporate and/or use aspects described herein. In one or more aspects, return determination module 700 includes, in one example, various sub-modules to be used to determine expected returns, timing, and reusability of configurable products and components thereof. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuitry thereof, such as computer(s) 101, EUD 103, server 104, or computers of cloud 105/106 of FIG. 1, as examples.

Referring to FIG. 7, return determination module 700 includes (i) profile maintaining sub-module 702 for maintaining product and client profiles based on collected data pertaining to products and clients to which those products are provided, (ii) model building and training sub-module 704 for building and training a set of models configured to identify products that are expected to be returned in the future, predict retention times for those products, and determine reusable components of those products, (iii) predicting sub-module 706 to use the set of models against one or more products in use and identify which of those products in use are expected to be returned in the future, and predict the retention times and determine reusable components of those predicted returns, and (iv) results aggregation and output sub-module 708 to aggregate the results of the predicting sub-module 706 to determine a collection of reusable components, timing when each reusable component of the collection will be available in the future, configuration of each reusable component of the collection, and quality of each reusable component of the collection, and identify product(s) for potential remanufacture and/or resell.

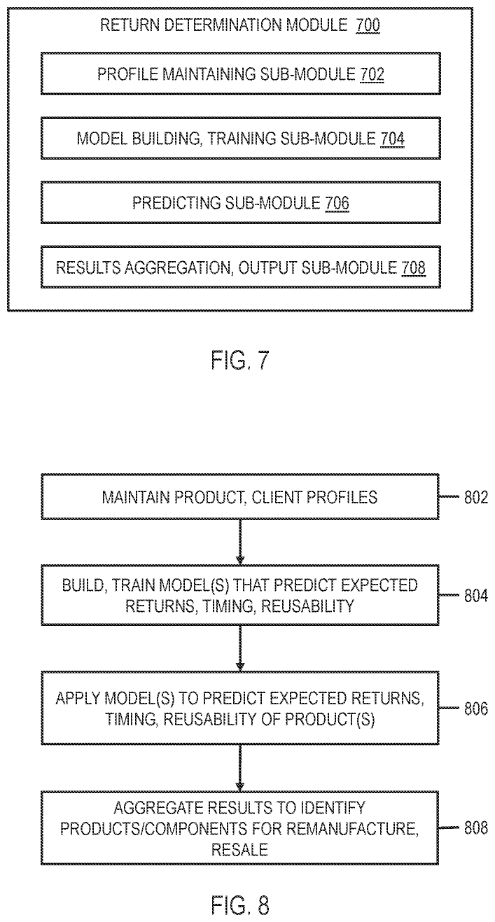

FIG. 8 depicts an example process for return determination, for instance determining expected returns, timing, and reusability of configurable products and components thereof, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 8 are part of a module, such as module 700. In other examples, the code may be included in one or more modules and/or in one or more sub-modules of the one or more modules. Various options are available.

The process of FIG. 8 includes maintaining (802) profiles, for instance product profiles and client profiles. The product profiles can be profiles of a plurality of products that each include respective components. The product profiles can indicate updated configurations of the plurality of products, including updated configurations of the respective components of the plurality of products. In examples, each of the products has an associated product profile that indicates updated configurations for the product and the respective components thereof. Maintaining a product profile for any given product can include obtaining order data associated with the product, the order data including details of product components at a time of provision of the product to a client, and maintaining a current configuration of the product by tracking and analyzing changes (alterations) in the configuration of the product over time, including alterations to the set of components of the product. Maintaining the product profile for the product could also include obtaining quality indicators from field quality data associated with the product and obtaining maintenance data indicating maintenance performed on the product. Also maintained are client profiles of client(s) to which the products are provided. A client profile can include any desired information about or related to the client, for instance (but not limited to) indications of client size, client industry, and/or client location.

The process builds and trains (804) a set of models based on at least some of the maintained product profiles. In this regard, there might be products that have been in use for some time and either returned or retained by the client during that time. The profile data associated with those products might serve as proper training data for the model(s). In this regard, maintaining the product profiles of products can maintain a return status for each of the products, and the building and training of the model(s) uses the maintained return statuses in building and training (at least) the prediction model. Meanwhile, there might be other product profiles for products that were more recently put into use and/or for which predictions are to be made as to retention/return determination, timing, etc.

In any case, the set of models are built and trained based on training data taken from the maintained profiles. The models are configured by the training to perform (i) identifying products that are expected to be returned in the future, (ii) predicting retention times for products that are expected to be returned in the future, and (iii) determining, based on quality indicators of products that are expected to be returned in the future and on requirements for reusability of components, reusable components of products that are expected to be returned in the future. In specific examples, the set of models includes a prediction model that is configured to make a prediction as to whether a product is expected to be returned in the future, where the prediction is based, at least in part, on the maintained current configuration of that product as reflected by the product profile. The prediction by the prediction model could be based further in part on indications as to whether the product is current technology, whether previous technology remains available, and/or whether newer technology is available to replace the product, as examples. In addition, the prediction by the prediction model could be based further in part on the client profile being maintained of the client to which the product was provided. The client profile could indicate client size, industry, and/or location (among other client properties), as examples, the prediction could be based on such properties.

The set of models could also include a retention model that is configured to predict an amount of time a product will be retained from an initial date (such as the date of provision, delivery, shipping, etc. to the client) before it is returned. The predicted retention time could be added to the initial date to determine an expected timeframe of the return of the product.

The process of FIG. 8 also includes using/applying (806) the set of models to predict expected returns, riming, and reusability of product(s) and components thereof. This could be performed for any number of products in use and performed iteratively over time. In an example relative to a given product in use, the model(s) are used together with the appropriate information maintained about the product in use, for instance information of the product profile of the product in use, and more specifically the current configuration of the product in use, including a current configuration of the set of components of the product in use. The process uses the model(s) to determine whether the product in use is expected to be returned in the future and, if so, an expected timeframe of the return of the product in use. The retention model can predict an amount of time the product in use will be retained from an initial date before it is returned, and the determination of the expected timeframe of the return of the product in use include adding that predicted amount of time to the initial date. The process also uses the model(s) to determine one or more components, of the set of components of the product in use, that are reusable upon return of the product in the future. For instance, it compares the quality indicators associated with the product in use and the maintenance data indicating maintenance performed on the product in use to requirements for reusability of the components to determine which components of the product in use satisfy the requirements of reusability thereof.

As noted, the process can repeat this use/application of the model(s), together with maintained product profiles of the other products in use, for a collection of other products in use to determine which of the other products are expected to be returned in the future, and, of one or more that are expected to be returned, the components thereof that are reusable upon return of the one or more other products in the future.

The process of FIG. 8 continues by aggregating (808) results of using model(s) to identify products/components for potential remanufacture and/or resale. For example, the process could determine (i) a collection of reusable components, (ii) timing when each reusable component of the collection will be available in the future, (iii) configuration of each reusable component of the collection, and (iv) quality of each reusable component of the collection. Based on aggregating this data, the process could identify product(s) and/or component(s) to remanufacture or resell as-is, as examples.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
maintaining product profiles of a plurality of products, wherein the plurality of products includes respective components, and wherein the product profiles indicate updated configurations of the plurality of products, including updated configurations of the respective components of the plurality of products;
building and training a set of models based on at least some of the maintained product profiles, the set of models configured to perform:
identifying products that are expected to be returned in the future;
predicting retention times for products that are expected to be returned in the future; and
determining, based on quality indicators of products that are expected to be returned in the future and on requirements for reusability of components, reusable components of products that are expected to be returned in the future; and
using the set of models and a product profile, of the maintained product profiles, of a product in use, the product in use comprising a set of components and the product profile indicating a current configuration of the product in use, including a current configuration of the set of components:
determining that the product in use is expected to be returned in the future and an expected timeframe of the return of the product in use; and
determining one or more components, of the set of components of the product in use, that are reusable upon return of the product in the future.

2. The method of claim 1, wherein maintaining the product profile of the product in use comprises:
obtaining order data associated with the product in use, the order data including details of product components at a time of provision of the product in use to a client; and
maintaining a current configuration of the product in use by tracking and analyzing changes in configuration of the product over time, including alterations to the set of components of the product.

3. The method of claim 2, wherein the set of models comprises a prediction model configured to make a prediction that the product in use is expected to be returned in the future, the prediction based, at least in part, on the maintained current configuration.

4. The method of claim 3, wherein the prediction by the prediction model is based further in part on indications as to (i) whether the product in use is current technology, (ii) whether previous technology remains available, and (iii) whether newer technology is available to replace the product in use.

5. The method of claim 3, wherein the maintaining the product profiles of the plurality of products further comprises maintaining return of the plurality of products, and wherein the building and training the set of models uses the maintained return statuses in building and training the prediction model.

6. The method of claim 2, further comprising maintaining a client profile of the client to which the product in use was provided, the client profile comprising an indication of at least one selected from the group consisting of client size, client industry, and client location, and wherein the prediction by the prediction model is based further in part on the client profile.

7. The method of claim 1, wherein the set of models comprises a retention model configured to predict an amount of time the product in use will be retained from an initial date before it is returned, and wherein the determining the expected timeframe of the return of the product in use comprises adding the predicted amount of time to the initial date.

8. The method of claim 1, further comprising repeating, for a collection of other products in use, the using the set of models, together with maintained product profiles of the other products in use, wherein the repeating determines one or more other products in use that are expected to be returned in the future, and determines components, of the one or more other products, that are reusable upon return of the one or more other products in the future.

9. The method of claim 8, further comprising:
aggregating results of the using the set of models to determine a collection of reusable components, timing when each reusable component of the collection will be available in the future, configuration of each reusable component of the collection, and quality of each reusable component of the collection; and
based on the aggregating, identifying at least one product to remanufacture or resell as-is.

10. The method of claim 1, wherein maintaining the product profile of the product in use comprises:
obtaining quality indicators from field quality data associated with the product in use; and
obtaining maintenance data indicating maintenance performed on the product in use;
wherein the determining the one or more components that are reusable upon return of the product in use comprises comparing the quality indicators and the maintenance data to the requirements for reusability of components to determine which components of the product in use satisfy the requirements of reusability thereof.

11. The method of claim 10, wherein the requirements for reusability of components include safety or privacy related requirements that are required for reusability of components of the product in use.

12. A computer system comprising:
a memory; and
a processor in communication with the memory, wherein the computer system is configured to perform a method comprising:
maintaining product profiles of a plurality of products, wherein the plurality of products includes respective components, and wherein the product profiles indicate updated configurations of the plurality of products, including updated configurations of the respective components of the plurality of products;
building and training a set of models based on at least some of the maintained product profiles, the set of models configured to perform:
identifying products that are expected to be returned in the future;
predicting retention times for products that are expected to be returned in the future; and
determining, based on quality indicators of products that are expected to be returned in the future and on requirements for reusability of components, reusable components of products that are expected to be returned in the future; and
using the set of models and a product profile, of the maintained product profiles, of a product in use, the product in use comprising a set of components and the product profile indicating a current configuration of the product in use, including a current configuration of the set of components:
determining that the product in use is expected to be returned in the future and an expected timeframe of the return of the product in use; and
determining one or more components, of the set of components of the product in use, that are reusable upon return of the product in the future.

13. The computer system of claim 12, wherein maintaining the product profile of the product in use comprises:
obtaining order data associated with the product in use, the order data including details of product components at a time of provision of the product in use to a client; and
maintaining a current configuration of the product in use by tracking and analyzing changes in configuration of the product over time, including alterations to the set of components of the product.

14. The computer system of claim 13, wherein the set of models comprises a prediction model configured to make a prediction that the product in use is expected to be returned in the future, the prediction based, at least in part, on the maintained current configuration and based further in part on indications as to (i) whether the product in use is current technology, (ii) whether previous technology remains available, and (iii) whether newer technology is available to replace the product in use.

15. The computer system of claim 12, wherein the set of models comprises a retention model configured to predict an amount of time the product in use will be retained from an initial date before it is returned, and wherein the determining the expected timeframe of the return of the product in use comprises adding the predicted amount of time to the initial date.

16. The computer system of claim 12, wherein maintaining the product profile of the product in use comprises:
obtaining quality indicators from field quality data associated with the product in use; and
obtaining maintenance data indicating maintenance performed on the product in use;
wherein the determining the one or more components that are reusable upon return of the product in use comprises comparing the quality indicators and the maintenance data to the requirements for reusability of components to determine which components of the product in use satisfy the requirements of reusability thereof.

17. A computer program product comprising:
a computer readable storage medium readable by a processing circuit and storing instructions for execution by the processing circuit to:
maintain product profiles of a plurality of products, wherein the plurality of products includes respective components, and wherein the product profiles indicate updated configurations of the plurality of products, including updated configurations of the respective components of the plurality of products;
build and train a set of models based on at least some of the maintained product profiles, the set of models configured to perform:
identifying products that are expected to be returned in the future;
predicting retention times for products that are expected to be returned in the future; and
determining, based on quality indicators of products that are expected to be returned in the future and on requirements for reusability of components, reusable components of products that are expected to be returned in the future; and
use the set of models and a product profile, of the maintained product profiles, of a product in use, the product in use comprising a set of components and the product profile indicating a current configuration of the product in use, including a current configuration of the set of components, to:
determine that the product in use is expected to be returned in the future and an expected timeframe of the return of the product in use; and
determine one or more components, of the set of components of the product in use, that are reusable upon return of the product in the future.

18. The computer program product of claim 17, wherein the instructions for execution by the processing circuit to maintain product profiles of the plurality of products comprises instructions for execution by the processing circuit to maintain the product profile of the product in use, including instructions for execution by the processing circuit to:
obtain order data associated with the product in use, the order data including details of product components at a time of provision of the product in use to a client; and
maintain a current configuration of the product in use by tracking and analyzing changes in configuration of the product over time, including alterations to the set of components of the product; and
wherein the set of models comprises a prediction model configured to make a prediction that the product in use is expected to be returned in the future, the prediction based, at least in part, on the maintained current configuration and based further in part on indications as to (i) whether the product in use is current technology, (ii) whether previous technology remains available, and (iii) whether newer technology is available to replace the product in use.

19. The computer program product of claim 17, wherein the set of models comprises a retention model configured to predict an amount of time the product in use will be retained from an initial date before it is returned, and wherein the instructions for execution by the processing circuit to use the set of models and the product profile of the product in use to determine the expected timeframe of the return of the product in use comprises instructions for execution by the processing circuit to add the predicted amount of time to the initial date.

20. The computer program product of claim 17, wherein the instructions for execution by the processing circuit to maintain product profiles of the plurality of products comprises instructions for execution by the processing circuit to maintain the product profile of the product in use, including to:
obtain quality indicators from field quality data associated with the product in use; and
obtain maintenance data indicating maintenance performed on the product in use;
wherein the instructions for execution by the processing circuit to use the set of models and the product profile of the product in use to determine the one or more components that are reusable upon return of the product in use comprises instructions for execution by the processing circuit to compare the quality indicators and the maintenance data to the requirements for reusability of components to determine which components of the product in use satisfy the requirements of reusability thereof.
